(19) United States
(12) Patent Application Publication
(10) Pub. No.: US 2005/0108438 A1
(43) Pub. Date: May 19, 2005

(54) Heterogeneous synergetic computing system

(76) Inventor: Nikolai Victorovich Streltsov, Ekaterinburg (RU)

Correspondence Address: STITES & HARBISON PLLC, 1199 NORTH FAIRFAX STREET, SUITE 900, ALEXANDRIA, VA, 22314, US

(21) Appl. No.: 10/498,529

(22) PCT Filed: Dec. 13, 2001
(86) PCT No.: PCT/DK01/00827

(51) Int. Cl. G06F 3/00

(52) U.S. Cl. 710/1

(57) ABSTRACT

The invention relates to the architecture of high-performance parallel computing systems and discloses a heterogeneous synergetic computing system comprising N functional units and an each-to-each switchboard with L data inputs, M address inputs and M data outputs, with M≧L and one-to-one correspondence between address inputs and data outputs and where at least one of said functional units comprises a control device, an instruction memory and an operational device and having m data inputs, m address outputs and l data outputs, where m≦M and l≦L. The object of the invention is to obtain an extended area of application of such parallel computing systems, to increase the throughput by expanding the stream of data to be processed and to optimize hardware requirements.

### FIELD OF INVENTION

The invention is related to computers, namely to the architectures of high-performance parallel computing systems.

### DISCLOSURE OF THE INVENTION

High performance parallel processing as defined in an algorithm represented in the multi-layer form could be accomplished by a system consisting of an each-to-each N×2N switchboard, where N is the number of input operands, and N identical functional units implementing binary and unary operations. Results of operations are fed to the switchboard and are used as operands for the next layer of calculations.

Shortcomings of such a system are as follows:

identical functional units and their limitation to binary and unary operations restrict the application area of the architecture;

the use of the switchboard as the main source of operands limits the stream of data to be processed;

decentralized control and the need to synchronize data streams require additional hardware (control devices) in the functional units and non-productive delay instructions in software.

The present invention aims to extend the area of application of the synergetic computing system, to increase its throughput by expanding the stream of data to be processed, and to optimize hardware requirements.

According to the invention, the heterogeneous synergetic computing system contains N functional units and an each-to-each switchboard with L data inputs, M address inputs and M data outputs, where M≧L, with one-to-one correspondence between address inputs and data outputs, with at least one functional unit consisting of a control device, an instruction memory and an operational device, and having m data inputs, m address outputs and l data outputs, where m≦M, l≦L. There is a one-to-one correspondence between address outputs and data inputs, and each data input is uniquely connected to a data output of the switchboard, while the corresponding address output is connected to the switchboard address input corresponding to that data output of the switchboard. Each data output of the functional unit is uniquely connected to a data input of the switchboard. The data inputs of the functional unit are data outputs of the control device. The address outputs of the functional unit are the first m address outputs of the control device whose (m+1)-st address output is connected to the address input of the instruction memory; instruction input/output of the control device is connected to the instruction input/output of the instruction memory. Control output of the control device is connected to the control input of the operational device, m data outputs of the control device are respectively connected to m data inputs of the operational device, and l data outputs of the operational device are the data outputs of the functional unit; the operational device contains at least one input/output device and/or at least one arithmetic and logic unit and/or at least one data memory, connected in a known way and implementing a set of data processing procedures using m types of input data and producing l types of output data.

To reach the stated goals, the said functional unit may also have an external control input/output connected to an external control input/output of at least one other functional unit, and/or l local data inputs. The external control input/output of the functional unit of the external control input/output of this unit's control device, the local data inputs of the functional unit are the local data inputs of the control device, and each local data input is uniquely connected to a data output of the operational device in the said functional unit.

Additionally, among K functional units interconnected via the control input/output, at least one and at most K−1 functional units may consist of instruction memory and operational device and have m data inputs, m address outputs and l data outputs, where m≦M, l≦L. There is a one-to-one correspondence between address outputs and data inputs, and each data input of the functional unit is uniquely connected to one of the data outputs of the switchboard, while the corresponding address output is connected to the switchboard address input corresponding to the respective data output of the switchboard. Each data output of the functional unit is uniquely connected to a data input of the switchboard, the data inputs of the functional unit are data inputs of its operational device, and the address outputs of the functional unit are address outputs of the instruction memory. The external control input/output of the functional unit is an address input of the instruction memory and the first control input/output of the operational device. The instruction output of the instruction memory is connected to the second control input of the operational device, and the instruction output of the operational device is connected to the instruction input of the instruction memory; l data outputs f the operational device are the data outputs of the functional unit, and the operational device contains at least one input/output device and/or at least one arithmetic and logic unit and/or at least one data memory, connected to each other and implementing a set of data processing procedures.

An implementation variant of the foregoing device is a device with at least one of the said K functional units consisting of a control device, an instruction memory, and, optionally, an input/output device, and having an external control input/output which is an external control input/output of its control device. The address output of the control device is connected to the address input of the instruction memory, and instruction input/output of the control device is connected to the instruction input/output of the instruction memory. The control output of the control device is connected to the control input of the input/output device, and the data input of the control device is connected to the data output of the input/output device.

Construction features of the present device are essential and in their combination allow to extend the application area of synergetic computing systems, increase system throughput and optimize hardware requirements. These goals are reached as follows. Abandonment of homogeneity requirement and use of l-result m-adic operations allow to include heterogeneous functional units (distinct in their operation sets) into synergetic computing systems. Introduction of direct feedback from the outputs of the operational device to the input of the control device into the structure of the functional unit allows to organize in the control device a block of general-purpose registers providing for storage and use of online data. These registers may be accessed without using the switchboard. An additional external input/output allows the state of the functional units to be controlled, i.e. switched to the wait state and subsequently reactivated, by other functional units; it also allows to exclude control devices or operational devices from certain functional units, thereby reducing hardware footprint and energy consumption.

### SYNOPSIS OF DRAWINGS

The present invention is explicated by the following drawings:

FIG. 1 presents a block diagram of the heterogeneous synergetic computing system;

FIG. 2 presents possible implementations of functional units.

### BEST EMBODIMENT OF THE INVENTION

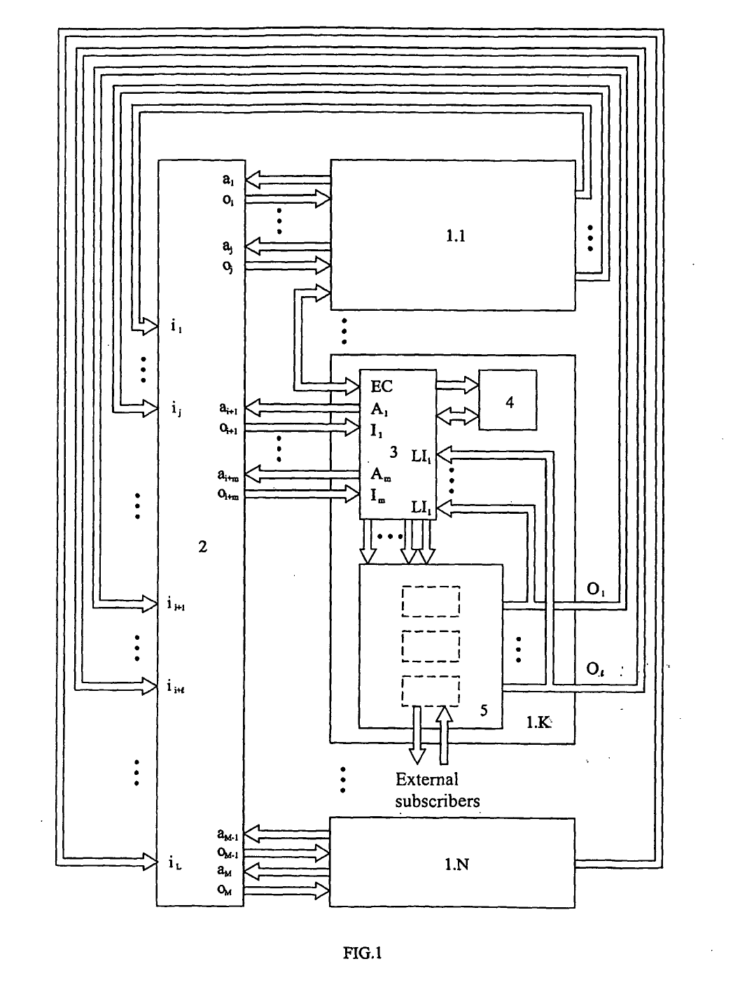

The heterogeneous synergetic computing system (FIG. 1) contains functional units 1.1, . . . , 1.K, 1.N, an each-to-each switchboard 2 with L data inputs i₁, . . . , iⱼ, . . . , iᵢ₊₁, . . . , iᵢ₊ₗ, . . . , i_{L}, M address inputs a₁, . . . , aⱼ, . . . , aᵢ₊₁, . . . , aᵢ₊ₘ, . . . , a_{M-1}, a_{M} and M data outputs o₁, . . . , oⱼ, . . . , oᵢ₊₁, . . . , oᵢ₊ₘ, . . . , o_{M<1}, o_{M}, where M≧L and there is a one-to-one correspondence between address inputs and data outputs (a₁ [symbol] oᵢ). The functional unit 1.K (shown in the diagram) consists of the control device 3, instruction memory 4 and operational device 5, and has m data inputs I₁, . . . , Iₘ, m address outputs A₁, . . . , Aₘ and l data outputs O₁, . . . , Oₗ, where m≦M, l≦L. There is a one-to-one correspondence between address outputs and data inputs (Aᵢ [symbol] Iᵢ), and each of the data inputs I₁, . . . , Iₘ of the functional unit is uniquely connected to one of the data outputs o_{i 1}, . . . , oᵢ₊ₘ of the switchboard, while the corresponding address outputs Aᵢ, . . . , Aₘ are connected to the address inputs aᵢ₊₁, . . . , aᵢ₊ₘ of the respective data outputs of the switchboard. Each of the data outputs Oᵢ, . . . , Oₗ of the functional unit is uniquely connected to one of the data inputs iᵢ₊₁, . . . , iᵢ₊ₗ of the switchboard; the data inputs of the functional unit are data inputs of the control device 3, the address outputs of the functional unit are the first m address outputs of the control device 3 whose (m+1)-st address output is connected to the address input of the instruction memory 4, the instruction input/output of the control device 3 is connected to the instruction input/output of the instruction memory 4, the control output of the control device 3 is connected to the control input of the operational device 5, m data outputs of the control device 3 are respectively connected to the m data inputs of the operational device 5, l data outputs of the operational device 5 are the data output of the functional unit, and the operational device 5 contains at least one input/output device and/or at least one arithmetic and logic unit and/or at least one data memory, implementing a set of data processing operations using m types of input data and producing l types of results.

The said functional unit also has an external control input/output EC connected to the control input/output of at least one other functional unit, and/or l local data inputs LI₁, . . . , LIₗ; the external control input/output EC of the functional unit is the external control input/output of the control device 3 in this unit. Local data inputs LI₁, . . . , LIₗ of the functional unit are the local data inputs of the control device 3, and each local data input is uniquely connected to a data output of the operational device 5 (LIᵢ [symbol] Oᵢ) in the said functional unit.

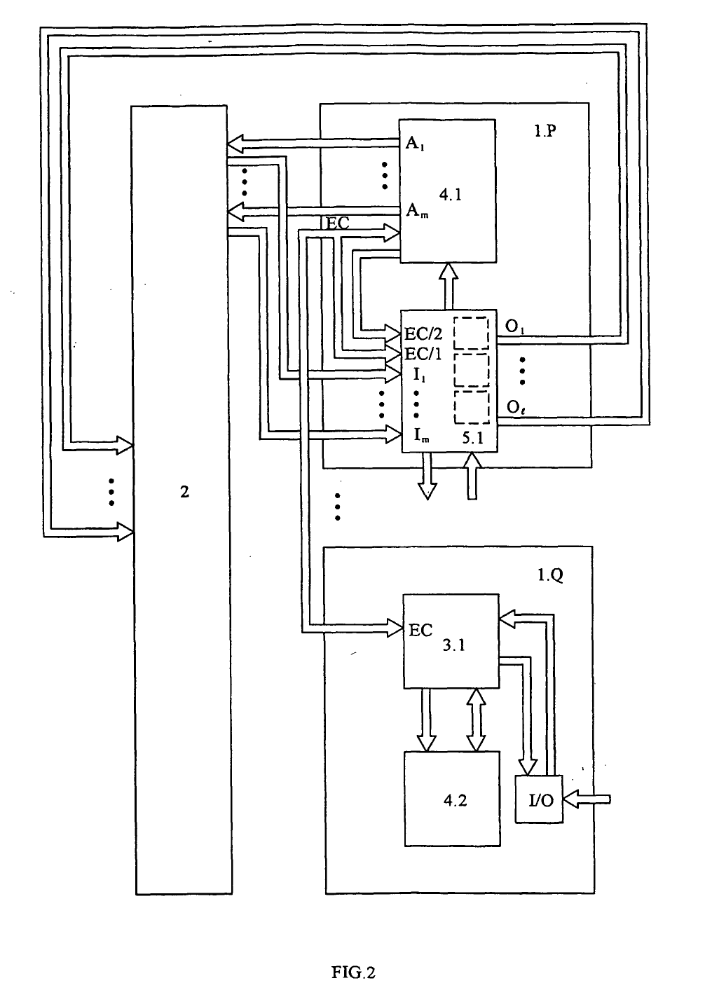

Functional unit implementations shown in FIG. 2 include the structures of units: 1.P consists of the instruction memory 4.1 and the operational device 5.1, and has m data inputs I₁, . . . , Iₘ, m address outputs A₁, . . . , Aₘ and l data outputs O₁, . . . , Oₗ, where m≦M, l≦L. There is a one-to-one correspondence between address outputs and data inputs (Aᵢ [symbol] Iᵢ), and each of the data inputs I₁, . . . , Iₘ of the functional unit is uniquely connected to one of the data outputs of the switchboard 2, while the corresponding address outputs A₁, . . . , Aₘ are connected to the respective address inputs of the switchboard 2 corresponding to those data outputs; each of the data outputs O₁, . . . , Oₗ of the functional unit is uniquely connected to a data input of the switchboard. The data inputs of the functional unit are the data inputs of the operational device 5.1, the address outputs of the functional unit are the address outputs of the instruction memory 4.1, the external control input/output EC of the functional unit is the address input of the instruction memory 4.1 and the first control input/output of the operational device 5.1, the instruction output of the instruction memory 4.1 is connected to the second control input of the operational device 5.1, the instruction output of the operational device 5.1 is connected to the instruction output of the instruction memory 4.1, l data outputs O₁, . . . , Oₗ of the operational device 5.1 are the data outputs of the functional unit, and the operational device 5.1 contains at least one input/output device and/or at least one arithmetic and logic unit and/or at least one data memory, implementing a set of data processing operations using m types of input data and producing l types of results.

Functional unit 1.Q (FIG. 2) consists of the control device 3.1, instruction memory 4.2, and, optionally, an input/output device, and has an external control input/output EC which us the external control input/output of the control device 3.1. The address output of the control device 3.1 is connected to the address input of the instruction memory 4.2, the instruction input/output of the control device 3.1 is connected to the instruction input/output of the instruction memory 4.2, the control output of the control device 3.1 is connected to the control input of the input/output device, and the data input of the control device 3.1 is connected to the data output of the input/output device.

The principle of operation of the synergetic computing system is known. A distinction of the heterogeneous synergetic computing system from the prior art is in the additional functionality provided by the architecture and implemented in the instruction set.

Thus, l-result m-adic operations for m=4 and l=2 can provide for implementation of complex number arithmetic without using a special packed form of complex numbers. The format is as follows:
<opcode mnemonic><number₁>, <number₂>, <number₃>, <number₄>,
where <number₁> is the address of the real part of the first number, <number₂> is the address of the imaginary part of the first number, <number₃> is the address of the real part of the second number, <number₄> is the address of the imaginary part of the second number.

The most practical way of using local data inputs is to feed the output data of the functional unit into a field of general-purpose registers and to create an orthogonal instruction set on this basis. Then, the opcode or a dedicated field contains flags controlling the acceptance of operands from the switchboard or from the registers in any combination thereof.

The additional external control channel between functional units in heterogeneous systems is used to control the computational process at both inter-unit and intra-unit levels.

Inter-unit control is a reconfiguration of the system, i.e. switching functional units to the wait state and their subsequent re-activation. To implement this functionality, an N-bit-wide state register is introduced into each functional unit, with the i-th bit of the register characterizing the state of the i-th functional unit, for example: 0=active, 1=waiting. Functional units are programmatically split into groups. In each group, one unit is assigned the “master” status and is allowed to set the value in the state register. A special instruction sets a new value in this register, thus reconfiguring the system, activating some functional units and suspending others.

Intra-unit control is a deeper level of control over the computational process. In this case, the instruction set is effectively divided between functional units the master unit sets the program starting address(es) for the slave units and synchronizes the fetching of instruction words by issuing the “execute next instruction” signal. The value in the flag register of a certain unit is sent to the master unit upon completion of the operation and s used to organize control transfers.

In this form of organization, some functional units (master units) may have no connection to the switchboard, and some may have no control device except for the instruction counter in the instruction memory.

### Industrial Applicability

The invention may be used for designing high-performance parallel computing systems in various applications, such as computation-intensive scientific and engineering problems, multimedia and digital signal processing. The invention may also be used for high-throughput switching centers in telecommunication systems.

1. A data processor comprising:
a) a plurality of functional units, each receiving input operands at input operand ports, and producing an output at a result port, at least one of the plurality of functional units comprising a control unit, an arithmetic unit and a program memory;
b) a switchboard selectively connecting the input operand ports of the functional unit to result ports of each of the other functional units.

2. Heterogeneous synergetic computing system according to claim 1, comprising N functional units, an each-to-each switchboard with L data inputs, M address inputs and M data outputs with M≧L and one-to-one correspondence between address inputs and data outputs, characterized that at least one functional unit consists of a control device, an instruction memory device and an operational device, and has m data inputs, m address outputs and l data outputs with m≦M, 1≦L, and one-to-one correspondence between the address outputs and the data inputs, where every data input of the functional unit is uniquely connected to one of the data outputs of the switchboard, and the corresponding address output is connected to the address input of the switchboard corresponding to its respective data output, every data output of the functional unit is uniquely connected to a data input of the switchboard, data inputs of the functional unit are the data inputs of the control device, address outputs of the functional unit are first m address outputs of the control device, (m+1)-th address output of the control device is connected to the address input of the instruction memory device, the instruction input/output of the control device is connected to the instruction input/output of the instruction memory device, the control output of the control device is connected to the control input of the operational device, m data outputs of the control device are respectively connected to m data inputs of the operational device, l data outputs of the operational device are the data outputs of the functional unit, and the operational device contains at least one input/output device and/or at least one arithmetic and logic unit and/or at least one data memory device connected by a known method and performing a set of data processing procedures using m types of input data and producing l types of output data.

3. Device according to claim 1 or 2, characterized that the said functional unit has an external control input/output connected to the external control input/output of at least one other functional unit, and/or I local data inputs, where the external control input/output of the said functional unit is the external control input/output of the control device for this functional unit, the local data inputs of the functional unit are the local data inputs of the control device, and every local data input is uniquely connected to a data output of the operating device in the said functional unit.

4. Device according to claim 1, 2 or 3, characterized that among K functional units connected via the control input/output, at least one but at most (K−1) functional units consist of an instruction memory device and an operational device and have m data inputs, m address outputs and l data outputs with m≦M, 1≦L, and a one-to-one correspondence between address outputs and data inputs, where every data input of the functional unit is uniquely connected to one of the data outputs of the switchboard, and the corresponding address output is connected to the address input corresponding to the respective data output of the switchboard, every data output of the functional unit is uniquely connected to a data input of the switchboard, data inputs of the functional unit are the data inputs of the operational device, address outputs of the functional unit are the address outputs of the instruction memory device, the external control input/output of the functional unit is the address input of the instruction memory device and the first control input/output of the operational device, the instruction output of the instruction memory device is connected to the second control input of the operational device, and the instruction output of the operational device is connected to the instruction input of the instruction memory device, l data inputs of the operational device are the data outputs of the functional unit, and thee operational device contains at least one input/output device and/or at least on arithmetic and logic unit and/or at least one data memory device connected by a known method and performing a set of data processing procedures using m types of input data and producing l types of output data.

5. Device according to any preceding claims, characterized that at least one functional unit of the said K functional units consists of a control device, an instruction memory device, may contain an input/output device, and has an external control input/output which is the external control input/output of the control device, the address output of the control device is connected to the address input of the instruction memory device, the instruction input/output of the control device is connected to the instruction input/output of the instruction memory device, the control output of the control device is connected to the control input of the input/output device, and the data input of the control device is connected to the data output of the input/output device.
